(19) United States
(12) Patent Application Publication
(10) Pub. No.: US 2022/0048238 A1
(43) Pub. Date: Feb. 17, 2022

(54) HALF SHELL

(71) Applicant: MAGNA Energy Storage Systems GesmbH, Sinabelkirchen (AT)

(72) Inventor: Mario DREBES, Sengenthal (DE)

(21) Appl. No.: 17/394,878

(22) Filed: Aug. 5, 2021

(30) Foreign Application Priority Data
Aug. 17, 2020 (EP) 20191403.3

(51) Int. Cl. B29C 51/06; F17C 1/16; B29C 51/14; B29C 51/10

(52) U.S. Cl. CPC B29C 51/06; F17C 1/16; B29C 51/14; B29C 51/10; B29K 2023/065; F17C 2203/066; F17C 2203/0619; F17C 2209/234; F17C 2209/2127

(57) ABSTRACT

A method for producing a half shell for a hollow body includes applying a preheated plastics sheet to a first tool half that forms a die, and then pre-stretching the plastics sheet, at least in certain regions thereof, by blowing or suctioning away, at least certain sections of the plastics sheet from the first tool half. The plastics sheet is then suctioned or pressed, via pressure or negative pressure, onto the first tool half, at least in certain regions.

### CROSS-REFERENCE TO RELATED APPLICATIONS

The present application claims priority under 35 U.S.C. § 119 to European Patent Publication No. EP 20191403.3 (filed on Aug. 17, 2020), which is hereby incorporated by reference in its complete entirety.

### TECHNICAL FIELD

One or more embodiments relate to a method for producing a half shell for a hollow body, in particular, a hollow body for a motor vehicle tank.

### BACKGROUND

It is known to produce hollow bodies, such as tanks for motor vehicles, from two half shells which are joined to one another at their edges. Various technologies are known for the production of hollow bodies. Primarily known is the blow moulding and thermoforming of plastic tanks, in which heated plastics sheets are pressed into a mould via compressed air or via vacuum in order to mould the half shells.

Depending on the form of the half shell, during the shaping regions of the material of the half shell that are thinned to a greater or lesser extent are produced, since the material is distributed over areas of different sizes during the deep drawing or moulding. The thinning is thus distributed unevenly over the component depending on the final geometry of the component. In order to prevent undesirably thin regions of the half shell, it is therefore necessary to use correspondingly thick starting sheets for the forming, which starting sheets also result in unnecessarily great wall thicknesses of the final half shell in less-thinned regions of the half shell.

### SUMMARY

In accordance with one or more embodiments, a method is presented for producing a half shell for a hollow body to prevent undesirably thick and thin regions of the material of the half shell.

In accordance with one or more embodiments, a method for producing a half shell for a hollow body, in which a tool with a first tool half that forms a die is used, the method comprising: applying a preheated plastics sheet to the first tool half; suctioning or pressing the plastics sheet onto the first tool half at least in certain regions via negative pressure or pressure; and blowing away or suctioning away the plastics sheet from the first tool half, at least in certain regions, via pressure or negative pressure before said plastics sheet is suctioned or pressed onto the first tool half, in order to pre-stretch the material of the plastics sheet at least in certain regions.

In accordance with one or more embodiments, a half shell is moulded from a plastics sheet. For this purpose, the plastics sheet is applied, for example, placed, onto a shaping tool that comprises the first tool half. After this, even before the actual moulding of the half shell, the material of the plastics sheet is not suctioned or blown into the mould, but rather the material of the plastics sheet is blown away from the shaping tool substantially in the opposite direction or suctioned in this opposite direction at least in certain portions. As a result, the material is pre-stretched in desired regions in a targeted manner in order to achieve a desired thinning of the material in these regions. During the further shaping, in the first tool half, a thinning is effected specifically in those regions which during the pre-stretching were stretched to a lesser extent or not stretched at all and thus were thinned to a lesser extent or not thinned at all. The targeted pre-stretching of the material of the plastics sheet in certain regions can be effected in particular, by holding back other regions of the plastics sheet in a targeted manner during the pre-stretching, in particular, via suitable retaining elements or slides.

In this way, the wall thickness and the thinning of wall regions of the half shell achieved overall can be influenced in a targeted manner. It is not necessary to use undesirably thick plastics sheets, which also form unnecessarily thick wall regions in the finished component, the half shell, or the hollow body or container produced overall.

In accordance with one or more embodiments, the pressure can be built up, in particular, by applying compressed air. The negative pressure can be built up by applying a vacuum or a negative pressure.

In accordance with one or more embodiments, the plastics sheet can be preheated before the plastics sheet is applied to the first tool half or shortly after the plastics sheet is applied to the first tool half. The preheating of the plastics sheet can serve to soften the plastic and make it more readily able to be formed.

In accordance with one or more embodiments, at least one retaining element is arranged on the plastics sheet, in particular, moved onto the plastics sheet, before the plastics sheet is blown or suctioned away from the first tool half, with the result that subregions of the plastics sheet are held back by the retaining element, and therefore, these subregions of the plastics sheet are pre-stretched to a lesser extent or are not pre-stretched when the plastics sheet is being blown away or suctioned away.

In accordance with one or more embodiments, the retaining element or at least one of the retaining elements has a closed form around the periphery. In particular, the closed form comprises an annular form, with the result that the subregions of the plastics sheet that are pre-stretched to a lesser extent or are not pre-stretched when the plastics sheet is being blown away or suctioned away have a closed form around the periphery, in particular, an annular form. The contour of the retaining element can thus influence the thinning of the plastics sheet caused by pre-stretching in a targeted manner, since regions can be selected in which the material of the plastics sheet is blown away or suctioned away or not.

In accordance with one or more embodiments, the first tool half has a cavity into which the plastics sheet is suctioned or pressed at least in certain regions via negative pressure or pressure, wherein the retaining element extends the edge of the cavity. The pressure or negative pressure can be built up inside the retaining element. Subregions of the plastics sheet that lie outside the cavity are then pre-stretched to a lesser extent or are not pre-stretched when the plastics sheet is being blown away or suctioned away.

In accordance with one or more embodiments, if the first tool half has a cavity into which the plastics sheet is suctioned or pressed at least in certain regions via negative pressure or pressure, the retaining element, or one of the retaining elements, is arranged centrally over the cavity, such that subregions of the plastics sheet that lie centrally in the cavity are pre-stretched to a lesser extent or are not pre-stretched when the plastics sheet is being blown away or suctioned away. Particularly, a central retaining element can be combined with a retaining element which has a closed form around the periphery. The pre-stretching of the plastics sheet can then be reduced or prevented both in a radially external region and in a radially central region, with the result that an annular region between these two less-pre-stretched regions is pre-stretched and thinned to a greater extent. For example, during the subsequent forming process, this annular region thinned to a greater extent can occupy most of the cavity of the first tool half and/or form most of the half shell produced. The half shell produced can then mostly have a smaller wall thickness than the plastics sheet had before the processing. As set forth, described and/or illustrated herein, “centrally over the cavity” means within an edge of the cavity. In this case, the retaining element extends around a central point of the cavity in a plan view of the cavity. The retaining element may also be arranged over another held-back region of the cavity, with the result that the central point of the retaining element is not on the central point of the cavity.

In accordance with one or more embodiments, the tool comprises a second tool half that forms a punch that is moveable onto the first tool half after the plastics sheet has been suctioned or pressed via negative pressure or pressure onto the first tool half. In this way, the inner contour of the half shell is formed.

At the time of the blowing away or suctioning away, the second tool half is positioned such that, when the plastics sheet is being blown away or suctioned away, for subregions of the plastics sheet the path through the second tool half is delimited, and therefore, these subregions of the plastics sheet are pre-stretched to a lesser extent or are not pre-stretched when the plastics sheet is being blown away or suctioned away. The second tool half can therefore also be used as a retaining element.

In accordance with one or more embodiments, the half shell comprises an insert part, for example, a boss. The plastic of the plastics sheet is arranged laterally spaced apart from the insert part in certain regions behind an undercut of the insert part after the plastic has been suctioned or pressed via negative pressure or pressure onto the first tool half. After the plastic has been suctioned or pressed laterally behind the undercut of the insert part, the plastic of the plastics sheet is pressed or suctioned behind the undercut from a lateral spacing from the insert part onto the insert part via a slide or negative pressure or pressure. This results in filling of a space behind the undercut of the insert part with the plastic. The plastic of the plastics sheet that is pressed or suctioned behind the undercut from a lateral spacing from the insert part onto the insert part via a slide or negative pressure or pressure comes from subregions of the plastics sheet that have been pre-stretched to a lesser extent or have not been pre-stretched. The plastic which is pre-stretched to a lesser extent and is therefore thicker can be thinned to a greater extent in order to fill the undercut.

In accordance with one or more embodiments, the plastics sheet comprises a multilayer composite. The multilayer composite comprises a layer of HDPE and a barrier layer, in particular, EVOH.

In accordance with one or more embodiments, to produce a hollow body, in particular, a container, a half shell is produced as set forth, described and/or illustrated herein. The half shell is connected to a second half shell or to at least one cylinder and an end cap, in order to form a closed container. The two half shells of the hollow body are produced in the manner set forth, described and/or illustrated herein.

In accordance with one or more embodiments, a fibre material, particularly, a composite material comprising carbon fibres and/or glass fibres and/or epoxy resin, is wound around the closed hollow body, in particular, container.

Developments of the invention are specified in the dependent claims, the description and the appended drawings.

### DRAWINGS

One or more embodiments will be illustrated by way of example in the drawings and explained in the description below.

FIGS. 1 through 12 illustrate schematic process blocks of a method for producing a half shell, in accordance with one or more embodiments.

### DESCRIPTION

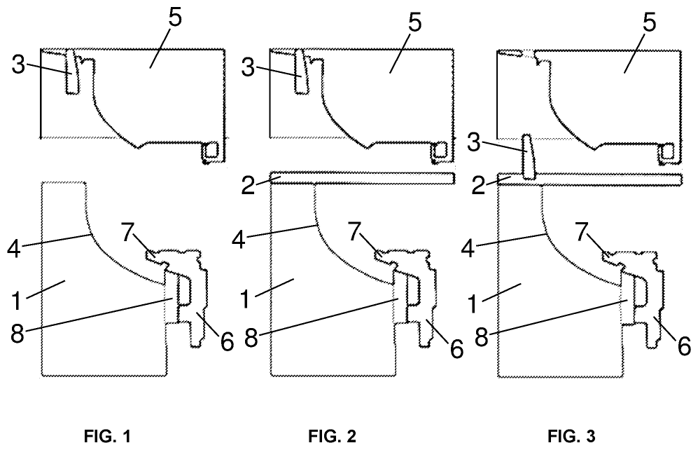

FIGS. 1 through 12 illustrate the process blocks of a method for producing a half shell for a hollow body such as a plastic container for a motor vehicle. Only the left half of the arrangement, which is mirror-symmetric with respect to a vertical axis, is illustrated in each case.

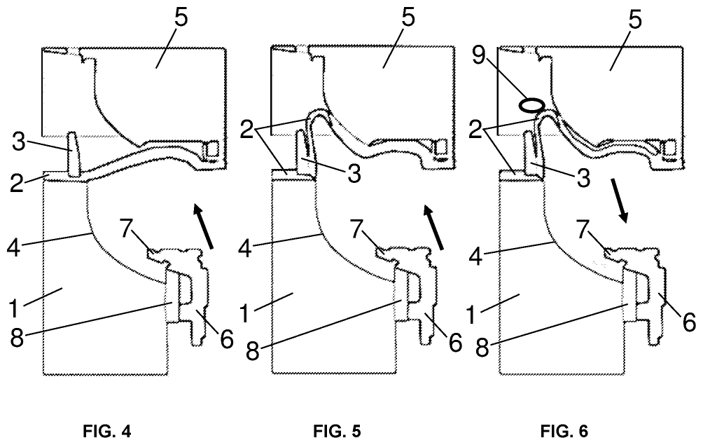

In the illustrated process block of FIG. 1, in a starting position, a tool with a first, lower tool half 1 that forms a die for the purpose of forming a plastics sheet being used. For this purpose, the first tool half 1 has a cavity 4 against which a plastic can be suctioned or blown in order to give it the form of the half shell. The tool also comprises a second tool half 5, which is arranged above the first tool half 1 and forms a punch. The form of the punch of the second tool half 5, as the positive form, substantially corresponds to the negative form formed by the cavity 4 of the first tool half 1. The second tool half 5 can be moved onto the first tool half 1, in order later to form the inner contour of the half shell. The second tool half 5 also comprises a retaining element 3 with a closed form circularly around the periphery, that is to say an annular form. The retaining element 3 serves to hold back subregions of a placed-on plastics sheet 2 (as illustrated in FIG. 2), with the result that these subregions of the plastics sheet 2 are pre-stretched to a lesser extent or are not pre-stretched when the plastics sheet 2 is being blown away or suctioned away (as illustrated in FIG. 4).

An insert part 6, specifically a boss for the half shell to be produced, is already placed in the first tool half 1 in FIG. 1. The insert part 6 is lifted via a slide 8 of the first tool half 1 into a raised position, in which an undercut 7 of the insert part 6, specifically an axial region of the insert part 6, with a larger periphery than other axial regions of the insert part 6, is arranged above the cavity 4 and spaced apart from this cavity 4. Plastic of the placed-on plastics sheet 2 can later be introduced into the space between the undercut 7 and the cavity 4 in order to fill the undercut.

In the illustrated process block of FIG. 2, a preheated plastics sheet 2 is applied to, in particular, placed onto, the first tool half 1. The plastics sheet 2, before being placed onto the first tool half 1, may be heated to a predetermined value of approximately 230 degrees Celsius, or heated on the first tool half 1 in order to preheat it, with the result that the plastics sheet 2 can be readily deformed. The plastics sheet 2 can comprise a multilayer composite plastic. The multilayer composite comprises a layer of HDPE and a barrier layer, in particular, EVOH.

In the illustrated process block of FIG. 3, the retaining element 3, an annular slide of the second tool half 5, is extended into a working position on the top side of the plastics sheet 2 in order to retain the corresponding regions of the plastics sheet during the subsequent pre-stretching of the plastic. The plastics sheet 2 is pressed down around the periphery by the retaining element 3 and sealed off with respect to the first tool half 1.

In the illustrated process block of FIG. 4, the pre-stretching of the plastic of the plastics sheet 2 via excess pressure finally begins by introducing compressed air in the direction of the arrow depicted, from the bottom, centrally in the first tool half. The plastic is therefore blown away and stretched upwardly towards the second tool half 5 in the regions which lie radially inside the retaining element 3.

In the illustrated process block of FIG. 5, now the punch of the upper, second tool half 5 likewise acts as a retaining element, and has the effect that central regions of the plastic of the plastics sheet 2 are stretched to a lesser extent. Therefore, at most an annular region of the plastics sheet 2 that lies between the retaining element 3 and the second tool half 5 is stretched.

In the illustrated process block of FIG. 6, now the maximum desired pre-stretching of the plastic is achieved, it being possible to detect this for example by way of a sensor 9 on the second tool half 5, and thus the excess pressure is ended and instead a negative pressure is created between the two tool halves 1, 5, in order to suction the plastic of the plastics sheet 2 that has been pre-stretched in subregions into the cavity 4 of the first tool half 1 (in the direction of the arrow depicted in FIG. 6).

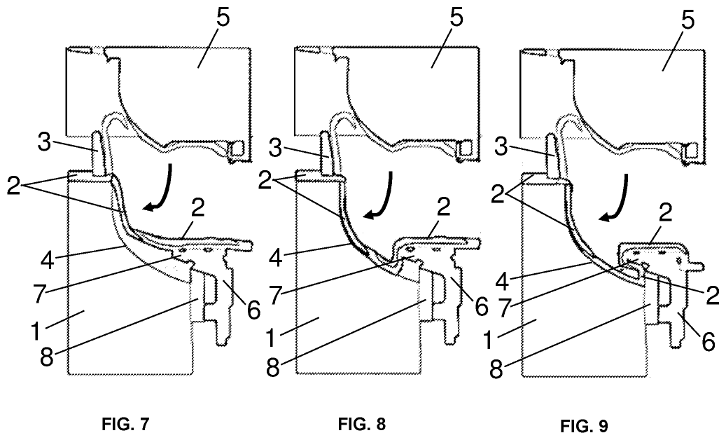

In the illustrated process blocks of FIG. 7 through FIG. 9, now the plastic previously located at the top on the second tool half 5 (still depicted in FIGS. 7 through 9) comes to lie in the cavity 4 of the first tool half 1 (in the direction of the arrow respectively depicted). The plastics sheet 2 is thus suctioned onto the first tool half 1 at least in certain regions via negative pressure. In this respect, the already pre-stretched material of the plastics sheet 2 primarily comes to lie against the cavity 4.

In the illustrated process block of FIG. 8, the plastic of the plastics sheet 2 is arranged laterally spaced apart from the insert part 6 in certain regions behind the undercut 7 of the insert part 6 after the plastic has been suctioned or pressed via negative pressure onto the first tool half 1.

In the illustrated process block of FIG. 9, the plastic of the plastics sheet 2 is subsequently pressed or suctioned behind the undercut 7 from a lateral spacing from the insert part 6 onto the insert part 6 via a slide or negative pressure or pressure, with the result that a space behind the undercut 7 of the insert part 6 between the undercut 7 and the cavity 4 is filled with the plastic. The plastic which is pressed or suctioned behind the undercut 7 of the insert part comes from regions of the plastics sheet 2 that have been pre-stretched to a lesser extent, and therefore, in FIG. 9, despite the material stretching behind the undercut, the plastic there has a sufficient wall thickness.

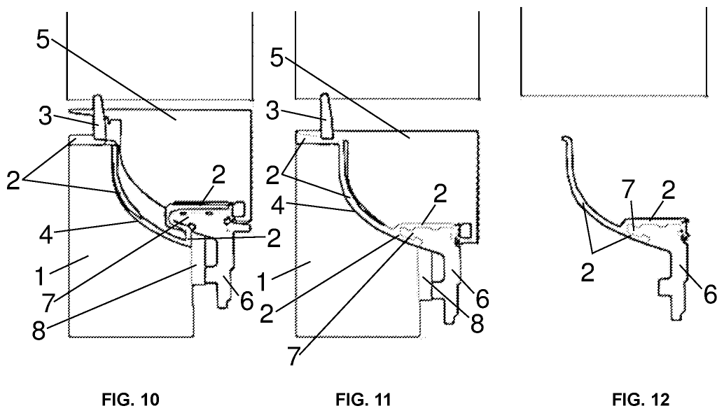

In the illustrated process block of FIG. 10, then the second tool half 5 is advanced vertically downwards, towards the first tool half 1. The second tool half 5 is moved up to the plastic of the plastics sheet 2, for example until it makes contact with the slide 8 or with a region of the insert part 6 (FIG. 10).

In the illustrated process block of FIG. 11, subsequently, for example, the slide 8 and thus the insert part 6 can be vertically lowered, and in the process the plastic in the region of the undercut, behind the undercut 7, can be pressed together or welded together.

In the illustrated process block of FIG. 12, the second tool half can then be lifted again into the starting position and the finished component can be removed from the tool, for example for cooling and/or for further processing. In particular, the finished half shell can be joined to a further half shell to form a hollow body, in particular, a container.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 First tool half

2 Plastics sheet

3 Retaining element

4 Cavity

5 Second tool half

6 Insert part

7 Undercut

8 Slide

9 Sensor

What is claimed is:

1. A method for producing a half shell for a hollow body, said method comprising:
applying a preheated plastics sheet to a first tool half that forms a die;
pre-stretching the plastics sheet, at least in certain regions thereof, by blowing or suctioning away, via pressure or negative pressure, the plastics sheet from the first tool half, at least in certain regions; and
suctioning or pressing, via pressure or negative pressure, the plastics sheet onto the first tool half, at least in certain regions.

2. The method of claim 1, further comprising, before pre-stretching the plastics sheet, arranging at least one retaining element on the plastics sheet to hold back subregions of the plastics sheet and thereby pre-stretch the subregions or prevent pre-stretching of the subregions when the plastics sheet is being blown away or suctioned away.

3. The method of claim 2, wherein the retaining element has an annular form in a manner such that the subregions of the plastics sheet that are pre-stretched or not pre-stretched have an annular form when the plastics sheet is being blown away or suctioned away.

4. The method of claim 3, wherein:
the first tool half has a cavity into which the plastics sheet is suctioned or pressed at least in certain regions the via negative pressure or pressure, and
the retaining element extends an edge of the cavity in a manner such that the subregions of the plastics sheet that lie outside the cavity are pre-stretched or not pre-stretched when the plastics sheet is being blown away or suctioned away.

5. The method of claim 2, wherein:
the first tool half has a cavity into which the plastics sheet is suctioned or pressed at least in certain regions via negative pressure or pressure, and
the retaining element is arranged centrally over the cavity in a manner such that the subregions of the plastics sheet that lie centrally in the cavity are pre-stretched or not pre-stretched when the plastics sheet is being blown away or suctioned away.

6. The method of claim 1, further comprising forming an inner contour of the half shell by moving a second tool half that forms a punch onto the first tool half.

7. The method of claim 1, further comprising positioning the second tool half, when the plastics sheet is being blown away or suctioned away, in a manner such that at subregions of the plastics sheet that a path through the second tool half is delimited, are pre-stretched or not pre-stretched.

8. The method of claim 1, wherein:
the half shell comprises an insert part, and
the plastic of the plastics sheet is arranged laterally spaced apart from the insert part in certain regions behind an undercut of the insert part after the plastic has been suctioned or pressed via negative pressure or pressure onto the first tool half.

9. The method of claim 8, wherein the plastic of the plastics sheet is pressed or suctioned behind the undercut from a lateral spacing from the insert part onto the insert part via a slide or negative pressure or pressure, to fill a space behind the undercut of the insert part with the plastic.

10. The method of claim 9, wherein the plastic of the plastics sheet that is pressed or suctioned behind the undercut from the lateral spacing from the insert part onto the insert part via a slide or negative pressure or pressure lies in subregions of the plastics sheet that are pre-stretched or not pre-stretched.

11. The method of claim 1, wherein:
the plastics sheet comprises a multilayer composite, and
the multilayer composite comprises a layer of HDPE and a barrier layer.

12. A method for producing a high-pressure container, the method comprising:
producing a half shell by:
applying a preheated plastics sheet to a first tool half that forms a die;
pre-stretching the plastics sheet, at least in certain regions thereof, by blowing or suctioning away, via pressure or negative pressure, the plastics sheet from the first tool half, at least in certain regions; and
suctioning or pressing, via pressure or negative pressure, the plastics sheet onto the first tool half, at least in certain regions, and
connecting the half shell to a second half shell or at least one cylinder and an end cap, in order to form a closed, hollow container body.

13. The method of claim 12, further comprising, after connecting the half shell to the second half shell or the at least one cylinder and the end cap, wounding a fibre material, a composite material comprising carbon fibres and/or glass fibres and/or epoxy resin, around the closed, hollow container body.

14. The method of claim 12, further comprising, before pre-stretching the plastics sheet, arranging at least one retaining element on the plastics sheet to hold back subregions of the plastics sheet and thereby pre-stretch the subregions or prevent pre-stretching of the subregions when the plastics sheet is being blown away or suctioned away.

15. The method of claim 14, wherein the retaining element has an annular form in a manner such that the subregions of the plastics sheet that are pre-stretched or not pre-stretched have an annular form when the plastics sheet is being blown away or suctioned away.

16. The method of claim 15, wherein:
the first tool half has a cavity into which the plastics sheet is suctioned or pressed at least in certain regions the via negative pressure or pressure, and
the retaining element extends an edge of the cavity in a manner such that the subregions of the plastics sheet that lie outside the cavity are pre-stretched or not pre-stretched when the plastics sheet is being blown away or suctioned away.

17. The method of claim 14, wherein:
the first tool half has a cavity into which the plastics sheet is suctioned or pressed at least in certain regions via negative pressure or pressure, and
the retaining element is arranged centrally over the cavity in a manner such that the subregions of the plastics sheet that lie centrally in the cavity are pre-stretched or not pre-stretched when the plastics sheet is being blown away or suctioned away.

18. The method of claim 12, further comprising forming an inner contour of the half shell by moving a second tool half that forms a punch onto the first tool half.

19. The method of claim 12, wherein:
the half shell comprises an insert part, and
the plastic of the plastics sheet is arranged laterally spaced apart from the insert part in certain regions behind an undercut of the insert part after the plastic has been suctioned or pressed via negative pressure or pressure onto the first tool half.

20. A high-pressure container, produced by a method comprising:
producing a half shell by:
applying a preheated plastics sheet to a first tool half that forms a die;
pre-stretching the plastics sheet, at least in certain regions thereof, by blowing or suctioning away, via pressure or negative pressure, the plastics sheet from the first tool half, at least in certain regions; and
suctioning or pressing, via pressure or negative pressure, the plastics sheet onto the first tool half, at least in certain regions, and
connecting the half shell to a second half shell or at least one cylinder and an end cap, in order to form a closed, hollow container body.
